(19) United States
(12) Patent Application Publication
(10) Pub. No.: US 2009/0255230 A1
(43) Pub. Date: Oct. 15, 2009

(54) GAS TURBINE

(75) Inventor: Frank Mildner, Rheinberg (DE)

Correspondence Address: SIEMENS CORPORATION;INTELLECTUAL PROPERTY DEPARTMENT, 170 WOOD AVENUE SOUTH, ISELIN, NJ, 08830, US

(73) Assignee: Renishaw Plc, Wooton-Under-Edge (GB)

(21) Appl. No.: 12/310,286

(22) PCT Filed: Jun. 27, 2007
(86) PCT No.: PCT/EP2007/056424

§ 371 Date: Feb. 19, 2009

(30) Foreign Application Priority Data
Aug. 22, 2006 (EP) 06017465.3

(51) Int. Cl. F02G 3/00

(52) U.S. Cl. 60/39.092

(57) ABSTRACT

A gas turbine having air cooling is provided with an effective measure for cleaning cooling air which is used in the turbine, which measure is particularly efficient. In order to allow comparatively pure, that is to say particle-free, compressed cooling air to flow into the cooling-channel system of the turbine, it is proposed that a protective element is provided for particle separation in a manner which is adjacent radially further to the outside to the removal opening, which protective element impedes particles which floating the compressor final air from flowing into the removal opening. As a result the clogging of cooling—air holes in impact-cooled turbine components which are loaded by hot gas can be avoided.

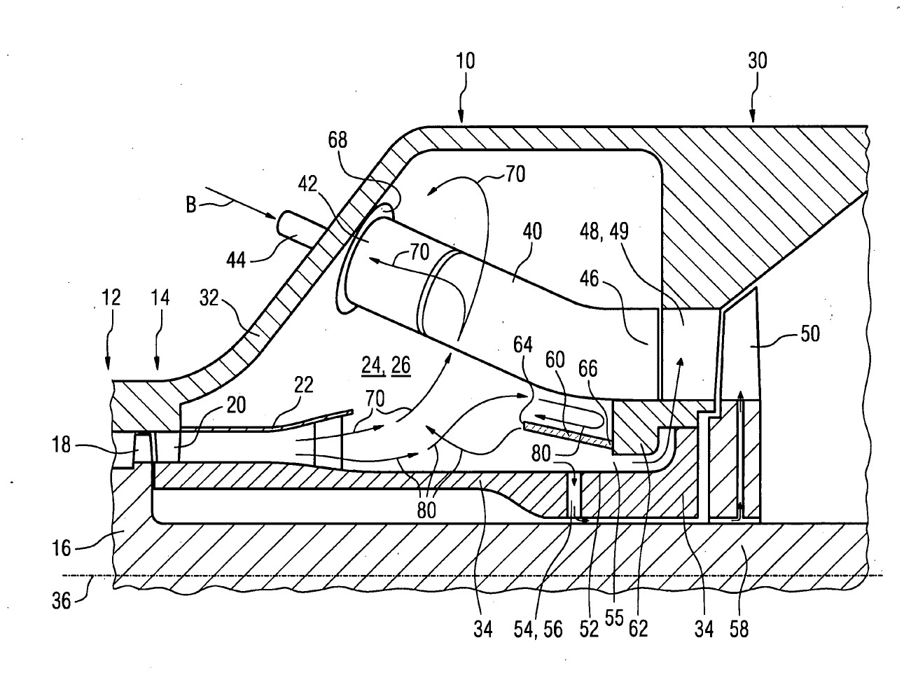

### CROSS REFERENCE TO RELATED APPLICATIONS

This application is the US National Stage of International Application No. PCT/EP2007/056424, filed Jun. 27, 2007 and claims the benefit thereof. The International Application claims the benefits of European Patent Office application No. 06017465.3 EP filed Aug. 22, 2006, both of the applications are incorporated by reference herein in their entirety.

### FIELD OF INVENTION

The invention refers to a gas turbine.

### BACKGROUND OF INVENTION

Gas turbines and their principle of operation are generally known. During the operation of the gas turbine, cooling air is required for cooling the turbine stator blades and rotor blades, with a cooling pressure level which customarily is made available at the outlet of the gas turbine compressor or of its diffuser, and is consequently extracted there. Although the compressed air which is made available by the compressor is already prefiltered in the inlet plenum which is connected upstream to the compressor, the filter which is arranged there is not adequate to clean in a requirement-dependent manner the cooling air which flows through the components of the gas turbine which are exposed to the hot gas. The dirt particles which are carried along by the compressor exhaust air represent a risk, at least for the part of the compressor exhaust air which is used as cooling air for turbine cooling. The risk lies especially in the blocking of the cooling air holes which are required for impingement cooling of the turbine blades on account of the dirt particles which are deposited thereupon and which are carried along in the cooling air. As a result, the necessary cooling of the turbine blades perhaps cannot be permanently ensured.

### SUMMARY OF INVENTION

For this reason, the cooling air which is made available to the turbine has to be cleaned by additional measures in order to exclude such malfunctions.

For this purpose, for example filtering tubes, which are arranged inside the gas turbine, are known, but give rise to high costs and, moreover, to a complicated construction.

Furthermore, plates for deflecting the particles, which are fastened at the compressor outlet, are known. U.S. Pat. No. 4,820,116 for example features such a deflector plate. The end of the plate which faces the compressor in this case is fastened on a diffuser wall. The other end of the plate, which faces the turbine, is free-standing and in this case partially projects over the extraction opening for cooling air, wherein an inflowing of cooling air in the radial direction is possible. This leads to dirt deposition rates which cannot be acceptable.

Based on this, the object of the invention is the provision of a generic-type gas turbine, in which a risk to the turbine cooling is further reduced.

For achieving the object, it is proposed with the invention that for the extraction opening a protective element for dirt particle deposition is adjacently provided radially further outwards, which impedes the inflowing of particles, which are suspended in the compressor exhaust air, into the extraction opening. The protective element in this case is formed as a separating plate which with its end which faces the turbine is connected in a fixed manner to the turbine-side casing. By means of this protective element, the cleanliness of the turbine cooling air is further improved, the portion of possibly harmful particles in the cooling air being significantly lowered so that blockages of cooling air holes can very rarely occur or even be avoided. Although the protective element is attached at a distance from the extraction openings and projects axially into the cavity, it has been proved that this protective element effectively prevents the inflowing of particles into the inlet openings of the cooling passage system of the turbine. In an unexpected way, moreover, the deflection of the flow of the compressor exhaust air which occurs in the cavity did not lead to impairment of the cooling of the air-cooled combustion chamber, which might have opposed the use of such a protective element.

The protective element is formed as an annular separating plate, as a result of which the extraction openings for cooling air, or all the extraction openings, are completely covered with a separating plate which is at a distance above them. In this manner, the separating plate especially prevents the inflowing of particles, which are carried along in the compressor exhaust air, into the extraction openings.

The proposed measures accordingly lead to a permanently damage-free cooling of turbine components, as a result of which both their service life and the availability of the gas turbine can be increased.

Advantageous developments of the inventions are disclosed in the dependent claims.

The development in which the protective element has an end which faces the compressor and an opposite end which is fastened on the turbine is particularly advantageous, wherein the turbine-side end is arranged on a smaller radius than the compressor-side end. Consequently, the protective element in the upper half of the gas turbine which is symmetrical to the machine axis forms an inclined plane upon which the particles can settle and form a deposit. The inclination of the protective element in this case is selected so that its free end which faces the compressor is located higher than its fixed end which faces the turbine. Consequently a particle trap for dirt particles which are suspended in the compressor exhaust air is thus formed in the upper half of the gas turbine. Also, the gravity-dependent inflowing of particles into the extraction openings is safely avoided in the upper half of the gas turbine in which this problem can occur.

In an advantageous development of the invention, the extraction opening, or each extraction opening, is provided in a surface of a shaft guard which encompasses the rotor. Alternatively to this, the extraction opening, or each extraction opening, can also be formed as a gap which is formed by a face-end surface of the rotor and by a fixed shaft guard. By means of these measures, the extraction of some of the compressor exhaust air as cooling air from the cavity can be carried out in a particularly fluidically efficient manner, and the cooling air can be directed to the rotor.

The deposition rates for particles can be particularly high if the protective element completely covers the extent of each extraction opening, as seen along the machine axis, but at a distance from each opening.

The invention, moreover, is especially used in a stationary gas turbine which is exposed to axial throughflow and which is equipped with a plurality of tubular combustion chambers which are arranged concentrically to the center axis and distributed uniformly over the circumference.

### BRIEF DESCRIPTION OF THE DRAWINGS

The invention is explained with reference to a drawing. The single FIGURE shows an abstract view through the longitudinal section of a gas turbine in the region between the outlet-side end of the compressor and the turbine inlet.

### DETAILED DESCRIPTION OF INVENTION

In detail, the FIGURE shows a longitudinal section through a stationary gas turbine 10, which is exposed to axial throughflow, in the axial section between outlet-side end of the compressor 12 and turbine inlet. Only the last compressor stage 14 of the compressor 12 of the gas turbine 10 is shown, with a rotor blade 18 which is arranged on the rotor 16, and a stator blade 20 which with regard to the air which flows through the compressor 14 is located downstream of the rotor blade. A compressor diffuser 22, through which the compressed air which issues from the end of the compressor 12 can flow into a cavity 24, is provided further downstream of the compressor stator blade 20. The cavity 24, which is also referred to as a combustion chamber plenum 26 or even as a plenum for short, is located between the compressor 12 and the turbine 30, as seen axially. As seen radially, the plenum 26 is arranged between a casing 32 which is located further outwards, and the rotor 16 which is located further inwards, or a shaft guard 34. The shaft guard 34 is arranged on the rotor side and encompasses this. On the compressor side, the shaft guard is connected in a rotationally fixed manner to the casing 32 via the compressor diffuser 22 or via the compressor stator blades 20, and on the turbine side is connected in a fixed manner to the stator blades 49 of the turbine 30. In addition, inside the plenum 26 a plurality of tubular combustion chambers 40 are provided, which are arranged concentrically to a machine axis 36 and distributed uniformly over the circumference, and of which only one is shown. Each tubular combustion chamber 40, on its closed end 42 which faces the compressor 12, has a burner 44 for feed of a combustible medium B. The open ends 46 of the tubular combustion chambers 40 which are opposite the closed ends 42 merge into an annular hot gas passage in which one of the stator blades 49 of the first turbine stage 48 is schematically represented. The turbine rotor blade 50 which is fastened on the rotor 16 follows further downstream.

The rotor 16 of the gas turbine 10, which is rotatable around the machine axis 36, comprises a plurality of rotor disks, although not represented, which are clamped to each other by means of a central tension bolt or a plurality of off-center tension bolts. Some of the rotor disks carry the rotor blades 18, 50 of compressor 12 and turbine 30.

In the fixed shaft guard 34, a plurality of holes 56, which are distributed along the circumference, are provided, the openings of which, which are arranged in the surface 52 of the shaft guard which faces the cavity 24, are formed as extraction openings 54. By means of these holes 56 the compressor exhaust air which is fed to the plenum 26 through the compressor diffuser 22 can be extracted partially for cooling turbine components. An annular second extraction opening 55 is provided between a stator blade shroud 62 of the stator blade 49 and a second section of the shaft guard 34. The extraction openings 54, 55 are therefore provided in those delimiting walls of the cavity 24 which are on the rotor side, i.e. radially on the inside. However, instead of the solution which is shown provision can be made to provide the extraction opening 54 directly in the rotor 16.

Downstream of the extraction openings 54, the extractable compressor exhaust air is fed via a cooling passage system 58, which is arranged in and/or on the rotor 16, to the rotor blades 50 of the first turbine stage 48 for cooling. The compressor exhaust air which can be extracted through the second extraction opening 55 is provided for cooling the turbine stator blade 49. Furthermore, the cooling air which is extracted from the plenum 26 can also be fed to further components of the rotor 16 which are exposed to the hot gas, or also to the components of the turbine.

The largest part of the compressor exhaust air which is fed to the plenum 26 first of all serves for cooling the tubular combustion chambers 40 and after that for hot gas production by combustion of the combustible medium B. For this purpose, the compressor exhaust air is fed via openings 68 to a combustion chamber passage system, which is only schematically shown, which directs it further to the burners 44.

In order to provide a particularly clean cooling air, i.e. cooling air laden with only exceptionally few dirt particles, for cooling turbine components, for example stator blades 49 and/or rotor blades 50, a protective element 60, which is radially further outwards than the extraction openings 54, 55 and at a distance from these, is provided for particle deposition and impedes the inflowing of particles, which are suspended in the compressor exhaust air, into the extraction openings 54, 55. The protective element 60 is formed as a separating plate which on the stator blade shroud 62, that is to say on the radially inner end of the stator blade 49, is connected in a fixed manner to the casing 32 of the turbine 30. For example, the protective element 60 as an annular separating plate can conically encompass the machine axis 36 so that its free end 64 which faces the compressor 12 is arranged on a larger radius than the opposite end 66 which is fixed on the turbine 30.

In an alternative development, the shaft guard 34, in comparison to the solution which is shown, can also be formed in a shortened manner so that extraction openings 54 which are arranged in the circumferential surface of the rotor 16 can be formed by holes which are distributed over the circumference and arranged in the rotor disk, and which are in flow communication with the cooling passage system 58.

The protective element 60, which in the drawing is shown above the extraction opening 54, brings about a deposition of the particles which are suspended in the compressor exhaust air, as described in the following. Particles in an order of magnitude of about 10 μm primarily follow the main flow 70 of the compressor exhaust air which issues from the compressor diffuser 22 so that these particles together with the greater part of the compressor exhaust air leave the plenum 26 through the openings 68 which are arranged on the tubular combustion chamber 40 in order to be fed to the burners 44 and to be combusted. The path of this main flow 70, inclusive of the small particles (˜10 μm) which are carried along by it, is represented essentially by means of the arrows which are shown with the designation 70.

Since the comparatively small particles in the plenum 26 follow the main flow 70, these do not reach the extraction openings 54, 55 of the cooling passage system 58, so that for this reason the horizontal separating plate does not have any significant influence for this size of particle.

Larger particles in an order of magnitude of more than 50 μm are kept from entering the cooling passage system 58 by means of the approximately horizontally arranged separating plate. Such large particles, which flow with the compressor exhaust air from the compressor diffuser 22, impinge upon the tubular combustion chamber 40 and are deflected downwards by this. This deflected part 80 of the compressor exhaust air then flows together with the particles in the direction of the turbine 30 and then, coming from radially outside, impinges upon the outer side of the separating plate. From here, the compressor exhaust air flows horizontally further in the direction of the compressor diffuser 22 or compressor 12. Since the protective element 60 projects over the entire axial extent of the extraction opening 54, the particles can be kept away from the extraction openings 54 of the cooling passage system 58 despite the force which acts upon them. Progressing further, the main flow 70 picks up the larger particles which are fed to the compressor 12 and transports them to the openings 68 where the particles then leave the plenum 26. This described path of the particles with an order of magnitude of greater than 50 μm is represented in the FIGURE by means of the arrows which are provided with the designation 80.

On account of the corner regions with comparatively slow flow velocities which exist above the fixed end 66 of the protective element 60, a deposition possibility for particles is also created at this point, which further increases the cleanliness of the cooling air. The particles which are deposited at this point are harmless for the gas turbine and its operation.

In all, an effective measure for cleaning cooling air which is used in the turbine 30, which is particularly efficient, is provided with the invention. In this way, comparatively clean compressed cooling air can flow into the cooling passage system 58 of the turbine 30, as a result of which the blocking of cooling air holes of the impingement-cooled turbine components, which are acted upon by hot gas, can be avoided.

1.-7. (canceled)

8. A gas turbine, comprising:
an rotor-side-extraction opening;
a casing in which a compressor, a combustion chamber, and a turbine are arranged in series along a machine axis, and with a rotor which extends along the machine axis;
a cavity provided in which the combustion chamber is arranged, the cavity concentric to an axis of the turbine, axially between the compressor and the turbine, and radially between the casing and the rotor; and
a protective element for particle deposition is adjacently provided radially further outwards to the rotor-side-extraction opening, the protective element impedes the inflowing of particles, which are suspended in the compressor exhaust air, into the rotor-side-extraction opening, the protective element formed as a separating plate having a first end facing the gas turbine, the first end connected in a fixed manner to the casing, and a second end facing the compressor, the second end being free-standing,
wherein an intake air, which is compressed in the compressor, is fed to the cavity as compressor exhaust air, and for turbine cooling some of the compressor exhaust air is extracted as cooling air from the cavity via the rotor-side extraction opening.

9. The gas turbine as claimed in claim 8, wherein the protective element is formed as an annular separating plate.

10. The gas turbine as claimed in claim 8, wherein the first end facing the gas turbine is arranged on a smaller radius than the second end facing the compressor.

11. The gas turbine as claimed in claim 8, wherein the rotor-side-extraction opening is provided in a surface of a shaft guard which faces the cavity.

12. The gas turbine as claimed in claim 9, wherein the rotor-side-extraction opening is provided in a surface of a shaft guard which faces the cavity.

13. The gas turbine as claimed in claim 8, wherein the rotor-side-extraction opening is formed as a gap formed by a face-end surface of the rotor and by a fixed shaft guard.

14. The gas turbine as claimed in claim 9, wherein the rotor-side-extraction opening is formed as a gap formed by a face-end surface of the rotor and by a fixed shaft guard.

15. The gas turbine as claimed in claim 8, wherein the protective element completely projects over the extent of the rotor-side-extraction opening.

16. The gas turbine as claimed in claim 14, wherein the protective element projects along the axis completely over the extent of rotor-side-extraction opening.

17. A stationary gas turbine exposed to axial throughflow, as claimed in claim 8, comprising:
a plurality of tubular combustion chambers which are uniformly distributed concentrically to the machine axis.
